(19) United States
(12) Patent Application Publication
(10) Pub. No.: US 2018/0176376 A1
(43) Pub. Date: Jun. 21, 2018

(54) SIP CONTROL APPARATUS, MOBILE COMMUNICATION SYSTEM AND EMERGENCY CALL CONTROL METHOD

(71) Applicant: NTT DOCOMO, INC., Tokyo (JP)

(72) Inventors: Motohiro Abe, Tokyo (JP); Itsuma Tanaka, Tokyo (JP); Shinya Takeda, Tokyo (JP)

(73) Assignee: NTT DOCOMO, INC., Tokyo (JP)

(21) Appl. No.: 15/516,505

(22) PCT Filed: Apr. 11, 2016
(86) PCT No.: PCT/JP2016/061714

§ 371 Date: Apr. 3, 2017

(30) Foreign Application Priority Data
Apr. 13, 2015 (JP) 2015-082006

(51) Int. Cl. H04M 3/51; H04L 29/06; H04M 3/42

(52) U.S. Cl. CPC H04M 3/5116; H04L 65/1006; H04L 65/1016; H04L 65/1046; H04W 4/90; H04L 65/1076; H04M 3/42042; H04M 3/42357; H04L 65/1069

(57) ABSTRACT

A SIP control apparatus is provided. The SIP control apparatus is connected to a management apparatus controlling call processing rules in an IP packet network, and controls an emergency call made by a user apparatus. The SIP control apparatus includes an obtaining unit configured to, in the case where an emergency call connection request received from the user apparatus is anonymous, obtain an international mobile subscriber identifier, IMSI, of the user apparatus from the management apparatus; and a selection unit configured to, in the case where the obtaining unit succeeds in obtaining the IMSI of the user apparatus from the management apparatus, select to continue processing the emergency call connection request, and, in the case where the obtaining unit fails to obtain the IMSI of the user apparatus from the management apparatus, select whether to continue or to reject processing the emergency call connection request.

### BACKGROUND OF THE INVENTION

### 1. Field of the Invention

The present invention relates to a SIP control apparatus, a mobile communication system and an emergency call control method.

### 2. Description of the Related Art

A mobile communication system is realized by a radio network including a base station apparatus and a core network including a switch. Further, standard specifications of communication methods and communication interfaces have been specified by the 3rd Generation Partnership Project (3GPP).

In the conventional 3rd generation (3G) technologies, audio services have been provided by a circuit switching domain. On the other hand, in Long Term Evolution (LTE), the circuit switching domain is not included and only a packet switched (PS) domain is included. Therefore, a technology called voice over LTE (VoLTE) is known which provides audio services by using IP multimedia subsystem (IMS) technologies in the mobile communication system which supports LTE.

There is a service called an emergency call (also referred to as an emergency report) as one of the audio services (refer to, for example, NPL 1). The emergency call is a service for connecting to an emergency agency such as a police or a fire department. In each country, rules are defined related to telephone numbers (calling numbers) corresponding to emergency agencies, related to necessity for reporting or not reporting a caller ID, related to necessity for providing or not providing a callback to an emergency call, related to reporting user location information, related to priority control of an emergency report, etc. An emergency call is provided also in VoLTE.

Further, in a user apparatus used for a mobile communication system which supports 3G or LTE, an IC card called Universal Integrated Circuit Card (UICC) is inserted and used for uniquely identifying a subscriber. There are several kinds of UICCs such as a Subscriber Identity Module (SIM), a Universal Subscriber Identity Module (USIM), an IP Multimedia Service Identity Module (ISIM), etc. In the case where audio services and packet services are provided for a user apparatus in a mobile communication system, authentication, etc., are performed by using information stored in the UICC in order to check a legitimate subscriber.

### CITATION LIST

### Non-Patent Literature

[NPL 1] TS23.167 V12.1.0 (2015-03)

### SUMMARY OF THE INVENTION

### Technical Problem

In the case where an emergency call is made by using VoLTE, a processing step called IMS Emergency Registration is started between a user apparatus and an IMS apparatus. In the case where a UICC is not installed in the user apparatus, or, in the case where a UICC is installed in the user apparatus but the IMS Emergency Registration has failed for some reason, the user apparatus makes a call by setting information indicating that the emergency call has been made with anonymity in a calling signal.

Here, in the conventional 3GPP standard specifications, operations of the core network supporting VoLTE are not sufficiently specified in the case where an emergency call is made with anonymity.

For example, in the conventional 3GPP standard specifications, a technology is specified which enables connection to an emergency agency in the case where a user apparatus without an inserted UICC makes an emergency call. On the other hand, in the case where a user apparatus without an inserted UICC makes an emergency call, whether the connection to the emergency agency should be allowed is defined in laws, etc., in each country.

However, in the conventional 3GPP standard specifications, there is no mechanism for the IMS apparatus to determine whether a UICC is inserted in the user apparatus, especially in the case where an emergency call is made with anonymity, and thus, the IMS apparatus cannot determine whether the call connection should be allowed even if the emergency call is made by a user apparatus without an inserted UICC.

Further, in the case where an emergency call is made, it is desirable for the core network to obtain location information of the user apparatus in order to transfer the emergency call to an emergency agency of an appropriate location, for example, to an emergency agency which is nearest to the current location of the user apparatus. However, in the conventional 3GPP standard specifications, in the case where an emergency call is made with anonymity, there is no mechanism for obtaining the location information of the user apparatus and transferring the emergency call to an emergency agency of an appropriate location.

Further, it is desirable to report a telephone number of the user apparatus to the emergency agency, which enables the emergency agency to provide a callback in the case where an emergency call connected between the user apparatus and the emergency agency is disconnected for some reason. However, in the conventional 3GPP standard specifications, there is no mechanism for reporting the telephone number of the user apparatus to the emergency agency in the case where the emergency call is made with anonymity.

In view of the above, the present invention has been made in order to provide a technology for appropriately controlling an emergency call in the case where the emergency call is made with anonymity.

### Solution to Problem

A SIP control apparatus is provided. The SIP control apparatus is connected to a management apparatus controlling call processing rules in an IP packet network, and controls an emergency call made by a user apparatus. The SIP control apparatus includes an obtaining unit configured to, in the case where an emergency call connection request received from the user apparatus is anonymous, obtain an international mobile subscriber identifier, IMSI, of the user apparatus from the management apparatus; and a selection unit configured to, in the case where the obtaining unit succeeds in obtaining the IMSI of the user apparatus from the management apparatus, select to continue processing the emergency call connection request, and, in the case where the obtaining unit fails to obtain the IMSI of the user apparatus from the management apparatus, select whether to continue or to reject processing the emergency call connection request.

Further, a mobile communication system is provided. The mobile communication system includes a management apparatus for controlling call processing rules in an IP packet network, a SIP control apparatus for controlling an emergency call made by a user apparatus, and an emergency call session control apparatus connected to a plurality of public safety answering points, PSAPs, for accepting an emergency call. The management apparatus includes a storage unit configured to obtain and store an international mobile subscriber identifier, IMSI, from the user apparatus, and a first transmission unit configured to transmit the IMSI of the user apparatus in the case where the IMSI of the user apparatus is stored in the storage unit. The SIP control apparatus includes an obtaining unit configured to, in the case where an emergency call connection request received from the user apparatus is anonymous, obtain an international mobile subscriber identifier, IMSI, of the user apparatus from the management apparatus; and a first selection unit configured to, in the case where the obtaining unit succeeds in obtaining the IMSI of the user apparatus from the management apparatus, select to continue processing the emergency call connection request, and, in the case where the obtaining unit fails to obtain the IMSI of the user apparatus from the management apparatus, select whether to continue or reject processing the emergency call connection request; and a second transmission unit configured to transmit an emergency call connection request signal to the emergency call session control apparatus in the case where the selection unit selects to continue processing the emergency call connection request from the user apparatus. The emergency call session control apparatus includes a second selection unit configured to, in the case where the emergency call connection request signal is received, select any one of the PSAPs to which the emergency call connection request signal is to be transmitted.

Further, an emergency call control method performed by a mobile communication system is provided. The mobile communication system includes a management apparatus for controlling call processing rules in an IP packet network, a SIP control apparatus for controlling an emergency call made by a user apparatus, and an emergency call session control apparatus connected to a plurality of Public Safety Answering Points, PSAPs, for accepting an emergency call. The emergency call control method includes a step of obtaining, by the management apparatus, an international mobile subscriber identifier, IMSI, from the user apparatus, and storing the IMSI in a storage unit; a step of obtaining, by the SIP control apparatus, the IMSI of the user apparatus from the management apparatus in the case where an emergency call connection request received from the user apparatus is anonymous; a step of selecting, by the SIP control apparatus, to continue processing the emergency call connection request in the case where the IMSI of the user apparatus is obtained from the management apparatus, and, selecting whether to continue or to reject processing the emergency call connection request in the case where the IMSI of the user apparatus is not obtained from the management apparatus; a step of transmitting, by the SIP control apparatus, an emergency call connection request signal to the emergency call session control apparatus in the case where the selection unit selects to continue processing the emergency call connection request from the user apparatus; and a step of selecting, by the emergency call session control apparatus, any one of the PSAPs to which an emergency call connection request signal is to be transmitted in the case where the emergency call connection request signal is received.

### Advantageous Effects of Invention

According to an embodiment, a technology is provided in which an emergency call is appropriately controlled in the case where the emergency call is made with anonymity.

### BRIEF DESCRIPTION OF THE DRAWINGS

FIG. 1 is a drawing illustrating an example of a system configuration of a mobile communication system according to an embodiment.

FIG. 2 is a drawing illustrating an example of a functional structure of a PCRF according to an embodiment.

FIG. 3 is a drawing illustrating an example of a functional structure of a P-CSCF according to an embodiment.

FIG. 4 is a drawing illustrating an example of a functional structure of an E-CSCF according to an embodiment.

FIG. 5 is a drawing illustrating an example of a hardware configuration of the PCRF, the P-CSCF, and the E-CSCF according to an embodiment.

FIG. 6 is a sequence diagram (No. 1) illustrating an example of processing steps of a mobile communication system according to an embodiment.

FIG. 7 is a sequence diagram (No. 2) illustrating an example of processing steps of a mobile communication system according to an embodiment.

FIG. 8 is a sequence diagram (No. 3) illustrating an example of processing steps of a mobile communication system according to an embodiment.

FIG. 9 is a sequence diagram (No. 4) illustrating an example of processing steps of a mobile communication system according to an embodiment.

### DETAILED DESCRIPTION OF THE PREFERRED EMBODIMENTS

In the following, referring to the drawings, embodiments of the present invention will be described. It should be noted that the embodiments described below are merely examples and the embodiments to which the present invention is applied are not limited to the following embodiments. For example, it is assumed that a mobile communication system according to an embodiment complies with, but is not limited to, VoLTE. An embodiment may include a system in which the IMS is used in other radio access systems (2G, 3G, GPRS, Wi-Fi (registered trademark), WiMAX (registered trademark), a fixed IP network, etc.). It should be noted that, in the present application specification and claims, the term “LTE” is used, not only for meaning a communication method corresponding to 3GPP release 8 or 9, but also for including a communication method corresponding to 3GPP release 10, 11, 12, 13, or later.

<Overview>

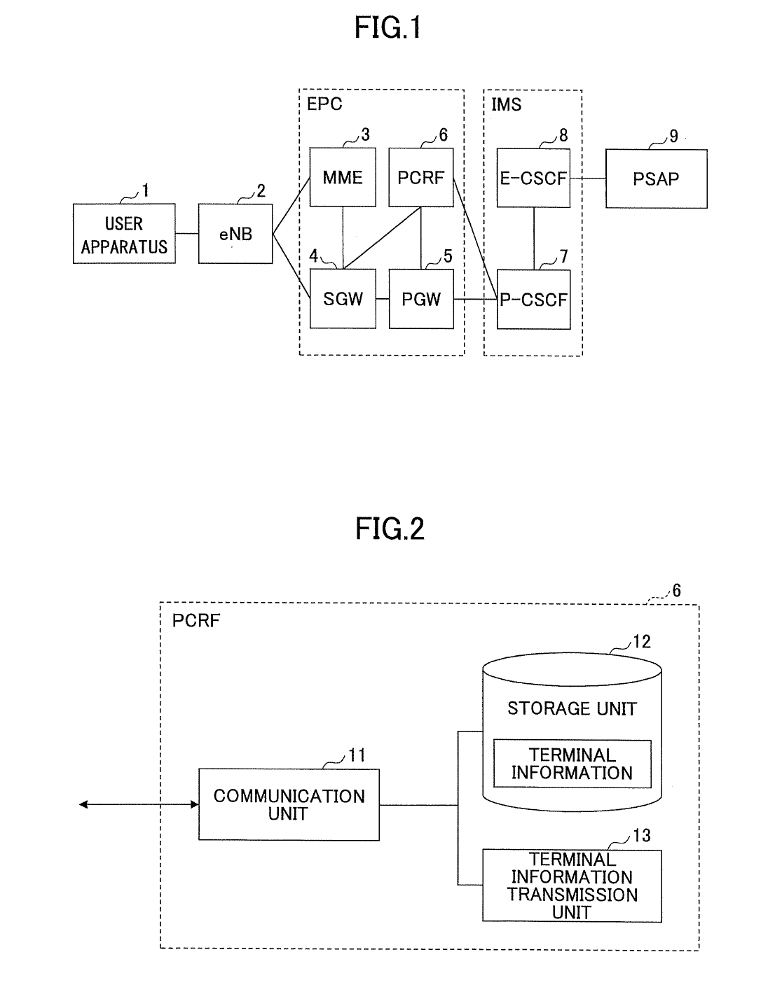

FIG. 1 is a drawing illustrating an example of a system configuration of a mobile communication system according to an embodiment. As illustrated in FIG. 1, the mobile communication system according to an embodiment includes a user apparatus 1, an evolved Node B (eNB) 2, a Mobility Management Entity (MME) 3, a Serving Gateway (SGW) 4, a Packet Data Network Gateway (PGW) 5, a Policy and Charging Rules Function (PCRF) 6, a Proxy-Call Session Control Function (P-CSCF) 7, an Emergency-Call Session Control Function (E-CSCF) 8, and a Public Safety Answering Point (PSAP) 9. The MME 3, the SGW 4, the PGW 5, and the PCRF 6 are apparatuses which belong to an evolved packet core (EPC). Further, the P-CSCF 7 and the E-CSCF 8 are apparatuses which belong to the IMS. It should be noted that the system configuration illustrated in FIG. 1 indicates apparatuses especially related to an embodiment only, and thus, the system further includes at least apparatuses for performing operations according to LTE (not shown in the figure). Further, though not specifically illustrated in the drawings, there are two kinds of control protocol options, a GPRS Tunneling Protocol (GTP) and a Proxy Mobile IP (PMIP), between the SGW 4 and the PGW 5. Any one of the GTP and the PMIP may be used.

The user apparatus 1 has a function for communicating with the eNB 2 and the apparatuses which belong to the EPC and the IMS via radio. The user apparatus 1 may be, for example, a mobile phone, a smartphone, a tablet, a mobile router, a personal computer, a wearable terminal, etc. The user apparatus 1 may be any apparatus as long as it has a communication function.

The eNB 2 is a base station in LTE, and performs communications with the user apparatus 1 via radio. Further, the eNB 2 is directly connected to the MME 3 and the SGW 4, and relays a C-plane signal transmitted and received between the user apparatus 1 and the MME 3, and a U-plane signal transmitted and received between the user apparatus 1 and the SGW 4.

The MME 3 is connected to the eNB 2 and the SGW 4, and provides a mobility control function of the user apparatus 1 and an EPC bearer control function of the SGW 4. The SGW 4 is a serving packet switch and relays a U-plane signal between the eNB 2 and the PGW 5. The PGW 5 is a gateway apparatus for the EPC to connect to an external network (to the IMS in an example of FIG. 1) and provides an IP address for the user apparatus 1, etc. The PCRF 6 has a function for controlling policy and charging rules based on quality of service (QoS) settings of the EPC bearer, subscriber information, etc. Further, the PCRF 6 has a function for storing various types of identifiers (an International Mobile Subscriber Identifier (IMSI), a Mobile Station International Subscriber Directory Number (MSISDN), an IP address, an International Mobile Equipment Identity (IMEI), etc.,) for uniquely identifying the user apparatus 1 in order to perform various functions of the PCRF 6.

The P-CSCF 7 is a Session Initiation Protocol (SIP) relay server located at a connection point to the EPC. Further, the P-CSCF 7 has, not only a function for relaying a SIP signal, but also a bearer control function such as ordering the EPC (especially, the PCRF 6) to perform bearer control such as QoS and new bearer setting. The E-CSCF 8 is a SIP relay server which has a function for processing an emergency call. Further, the E-CSCF 8 is connected to multiple PSAPs 9, and has a function for transferring an emergency call to a PSAP 9 of an appropriate location according to a location of the user apparatus 1. The PSAP 9 is an apparatus (phone) installed in a police station, a fire department, etc., for responding to an emergency call made by the user apparatus 1.

In a mobile communication system according to an embodiment, in the case where an emergency call is made by the user apparatus 1, the P-CSCF 7, which has received the emergency call, queries the PCRF 6 about whether an IMSI is stored in the user apparatus 1 and determines whether a UICC is inserted in the user apparatus 1 which has made the anonymous emergency call.

Further, in the mobile communication system according to an embodiment, location information of the user apparatus 1 is reported to the PSAP 9 in the case where connection of the anonymous emergency call of the user apparatus 1 is allowed. Further, in the mobile communication system according to an embodiment, an IMSI, a MSISDN, or both, obtained from the PCRF 6, are reported to the PSAP 9 in the case where it is determined that the UICC is inserted in the user apparatus 1.

<Functional Structure>

In the following, functional structure examples of the PORE 6, the P-CSCF 7 and the E-CSCF 8 which perform operations according to an embodiment will be described.

(PCRF)

FIG. 2 is a drawing illustrating an example of a functional structure of the PCRF 6 according to an embodiment. As illustrated in FIG. 2, the PCRF 6 includes a communication unit 11, a storage unit 12, and a terminal information transmission unit 13. It should be noted that FIG. 2 only illustrates functional units of the PCRF 6 especially related to an embodiment, and thus the PCRF 6 further includes at least functions for performing operations according to LTE (not shown in the figure). Further, a functional structure illustrated in FIG. 2 is merely an example. Functional classification and names of functional units may be anything as long as operations related to an embodiment can be performed.

The communication unit 11 has a function for transmitting and receiving various types of signals related to call processing to and from the SGW 4, the PGW 5, and the P-CSCF 7. Further, the communication unit 11 has a function for performing call processing based on the received various types of signals and transmitting necessary call processing signals to the SGW 4, the PGW 5, or the P-CSCF 7. Further, in the case where various types of identifiers of the user apparatus 1 are reported by the PGW 5, the communication unit 11 stores as terminal information the reported various types of identifiers in the storage unit 12.

The terminal information of the user apparatus 1 is stored in the storage unit 12. Here, the terminal information includes an IMSI, an International Mobile Equipment Identity (IMEI), an MSISDN, and an IP address, location information, etc. In the case where the terminal information transmission unit 13 is queried by the P-CSCF 7 about whether the terminal information of a specific user apparatus 1 is stored, the terminal information transmission unit 13 searches the stored terminal information for the terminal information of the specific user apparatus 1, and transmits the search result to the P-CSCF 7.

(P-CSCF)

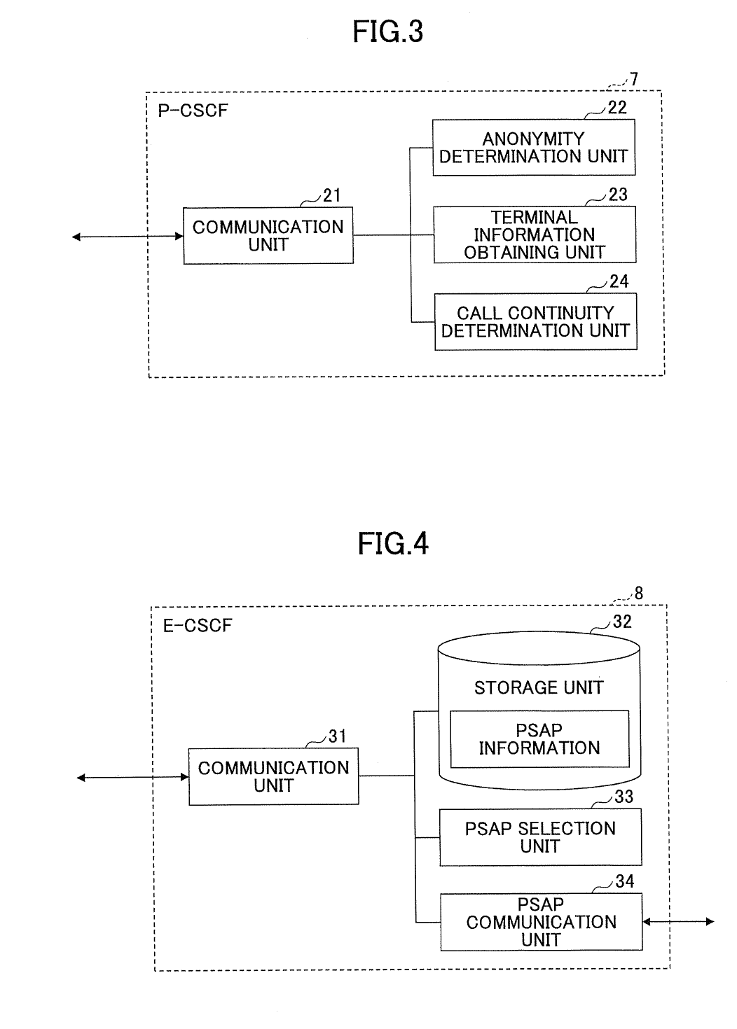

FIG. 3 is a drawing illustrating an example of a functional structure of the P-CSCF 7 according to an embodiment. As illustrated in FIG. 3, the P-CSCF 7 includes a communication unit 21, an anonymity determination unit 22, a terminal information obtaining unit 23, and a call continuity determination unit 24. It should be noted that FIG. 3 only illustrates functional units of the P-CSCF 7 especially related to an embodiment, and thus the P-CSCF 7 further includes at least functions for performing operations according to LTE (not shown in the figure). Further, a functional structure illustrated in FIG. 3 is merely an example. Functional classification and names of functional units may be anything as long as operations related to an embodiment can be performed.

The communication unit 21 has a function for transmitting and receiving various types of signals related to call processing to and from the PGW 5, the PCRF 6, and the E-CSCF 8. Further, the communication unit 11 has a function for performing call processing based on the received various types of signals and transmitting necessary call processing signals to the PGW 5, the PCRF 6, or the E-CSCF 8.

In the case where an emergency call is received via the communication unit 21, the anonymity determination unit 22 determines whether the received emergency call is anonymous based on parameters included in the emergency call.

In the case where it is determined by the anonymity determination unit 22 that the emergency call received from the user apparatus 1 is anonymous, the terminal information obtaining unit 23 obtains terminal information of the user apparatus 1 as a transmission source of the emergency call by querying the PCRF 6.

In the case where it is determined by the anonymity determination unit 22 that the emergency call received from the user apparatus 1 is anonymous and a UICC is not inserted in the user apparatus 1, the call continuity determination 24 determines whether call processing of the emergency call should be continued (that is, the emergency call should be connected to the PSAP 9), or the call processing of the emergency call should be rejected (that is, the emergency call should not be connected to the PSAP 9).

It should be noted that the call continuity determination unit 24 stores in advance permission information indicating whether the connection to the PSAP 9 should be allowed in the case where an emergency call is made by the user apparatus 1 without an inserted UICC. The permission information is defined according to the laws of each country. In the case where an anonymous emergency call is received from the user apparatus 1, the call continuity determination unit 24 determines whether the emergency call should be accepted and the call processing should be continued, or the call processing should be rejected, based on the permission information.

(E-CSCF)

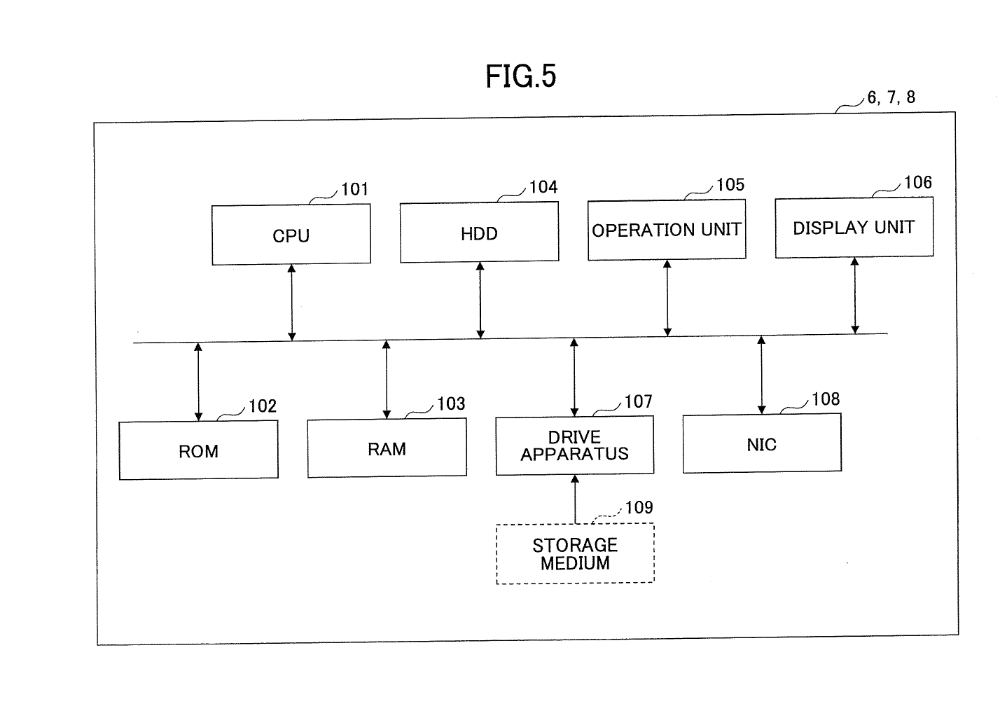

FIG. 4 is a drawing illustrating an example of a functional structure of the E-CSCF 8 according to an embodiment. As illustrated in FIG. 4, the E-CSCF 8 includes a communication unit 31, a storage unit 32, a PSAP selection unit 33, and a PSAP communication unit 34. It should be noted that FIG. 4 only illustrates functional units of the E-CSCF 8 especially related to an embodiment, and thus the E-CSCF 8 further includes at least functions for performing operations according to LTE (not shown in the figure). Further, a functional structure illustrated in FIG. 4 is merely an example. Functional classification and names of functional units may be anything as long as operations related to an embodiment can be performed.

The communication unit 31 has a function for transmitting and receiving various types of signals related to call processing to and from the P-CSCF 7. Further, the communication unit 31 has a function for performing call processing based on the received various types of signals and transmitting necessary call processing signals to the P-CSCF 7.

The storage unit 32 is used for storing PSAP information. In the stored PSAP information, for example, information indicating an installation location of each PSAP 9 is associated with connection information (address information) of the corresponding PSAP 9.

In the case where an anonymous emergency call is received from the P-CSCF 7, the PSAP selection unit 33 selects a PSAP 9 which is installed in an appropriate location as a transfer destination of the emergency call based on the location information included in the emergency call and the PSAP information stored in the storage unit 32.

The PSAP communication unit 34 has a function for transmitting and receiving various types of signals related to call processing to and from the PSAP 9.

<Hardware Structure>

FIG. 5 is a drawing illustrating an example of a hardware configuration of the PCRF 6, the P-CSCF 7, or the E-CSCF 8 according to an embodiment. The PCRF 6, the P-CSCF 7, or the E-CSCF 8 includes a CPU 101, a ROM 102, a RAM 103, an HDD 104, an operation unit 105, a display unit 106, a drive apparatus 107, and a network interface card (NIC) 108.

The CPU 101 is a processor for performing an entire control operation of the PCRF 6, the P-CSCF 7 or the E-CSCF 8. The CPU 101 executes an operating system stored in the HDD 104 or the like, an application, and programs of various services, and realizes various functions of the PCRF 6, the P-CSCF 7, or the E-CSCF 8. The ROM 102 stores various programs, data used by the programs, etc. The RAM 103 is used as a memory area for loading programs, as a work area of the loaded programs, etc. The HDD 104 is used for storing various information items, programs, etc.

The operation unit 105 is hardware used for accepting input operations from a user, and includes, for example, a keyboard or a mouse. The display unit 106 is hardware used for displaying things for the user.

The drive apparatus 107 reads programs from a storage medium 109 in which the programs are stored. The programs read by the drive apparatus 107 are installed, for example, in the HDD 104. The NIC 108 is a communication interface used for connecting the PCRF 6, the P-CSCF 7, or the E-CSCF 8 to a network, and for performing data transmission and reception.

It should be noted that the storage medium 109 is a non-transitory storage medium. As examples of the storage medium 109, there are a magnetic storage medium, an optical disk, a magneto-optical storage medium, a non-volatile memory, etc.

<Processing Steps>

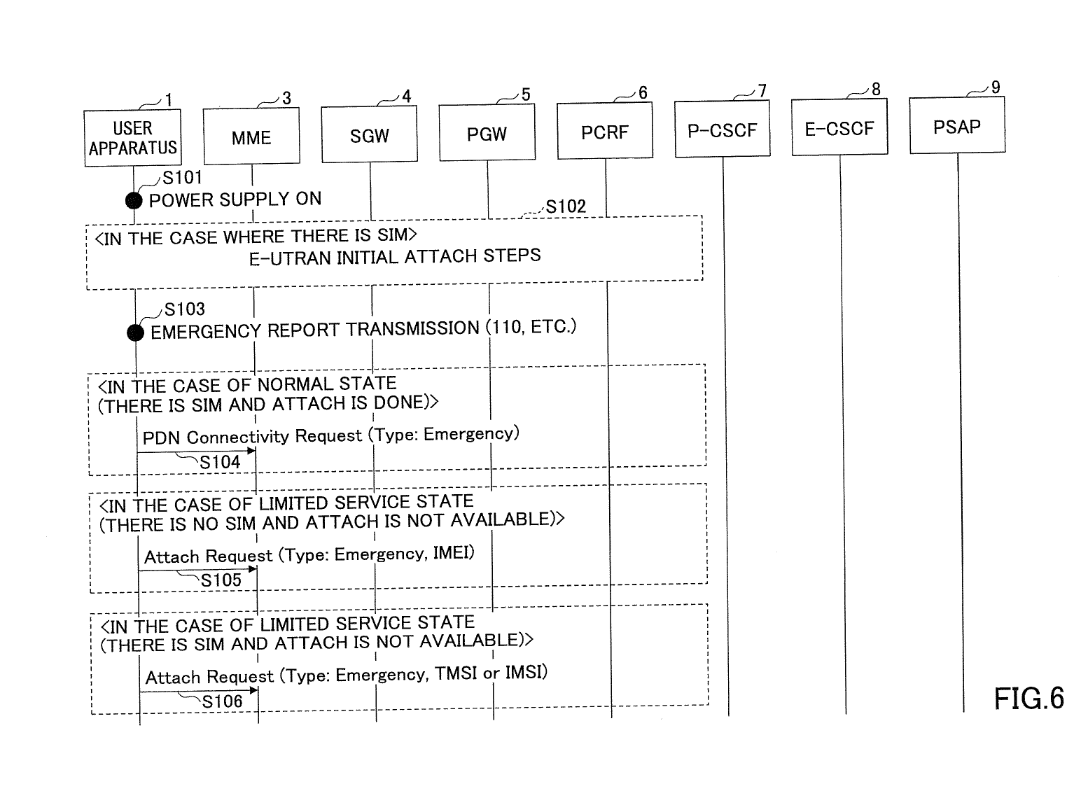

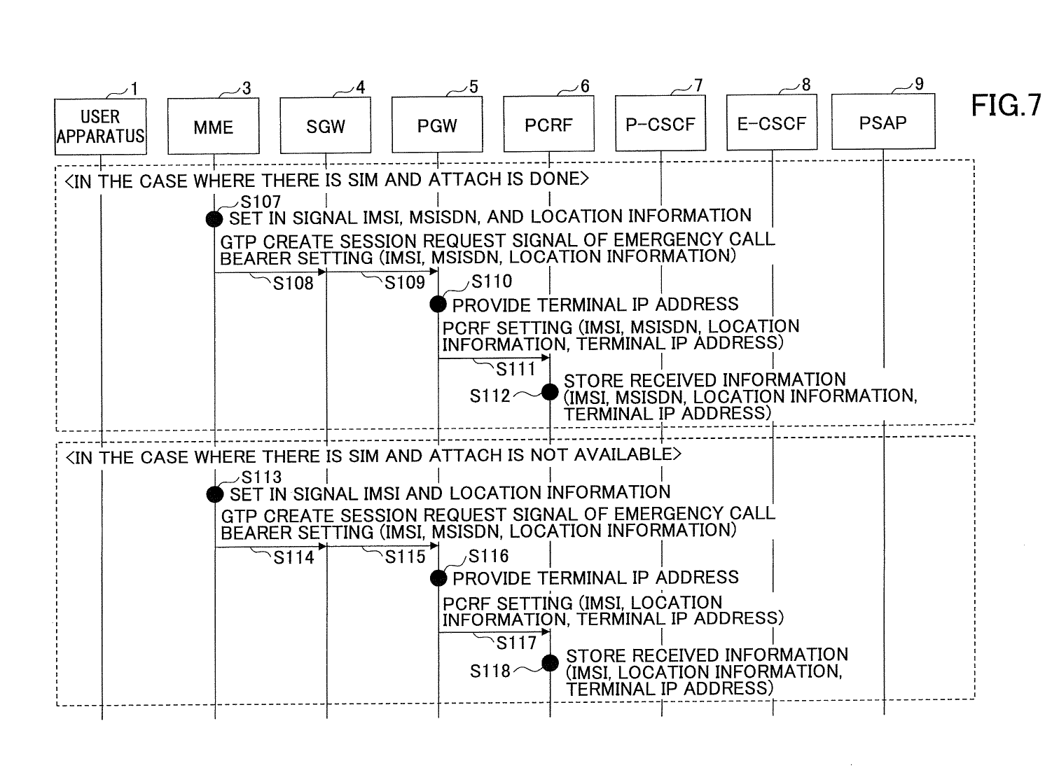

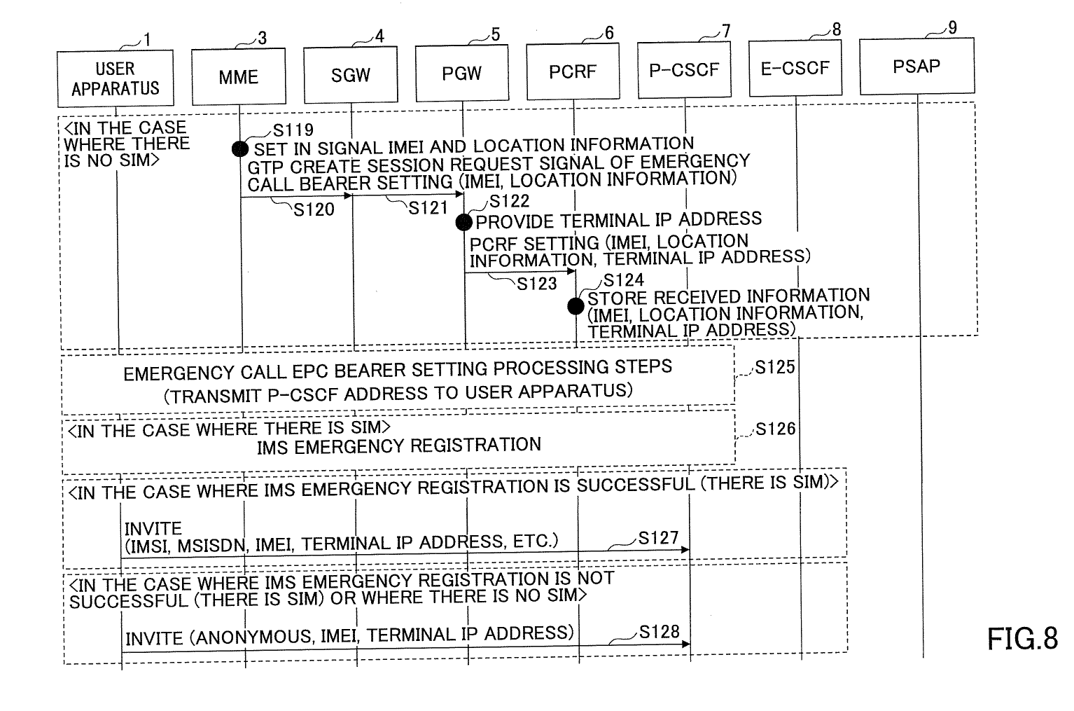

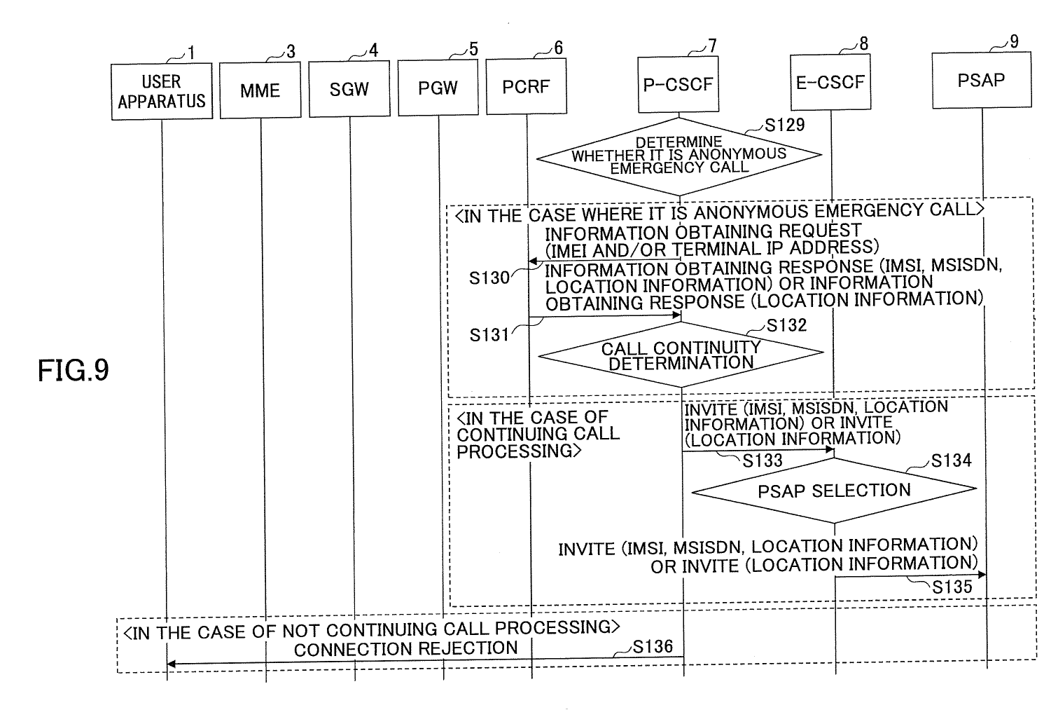

FIG. 6 is a sequence diagram (No. 1) illustrating an example of processing steps of a mobile communication system according to an embodiment. FIG. 7 is a sequence diagram (No. 2) illustrating an example of processing steps of a mobile communication system according to an embodiment. FIG. 8 is a sequence diagram (No. 3) illustrating an example of processing steps of a mobile communication system according to an embodiment. FIG. 9 is a sequence diagram (No. 4) illustrating an example of processing steps of a mobile communication system according to an embodiment. Referring to FIG. 6 through FIG. 9, processing steps will be described which steps are performed by a mobile communication system according to an embodiment for processing an emergency call made with anonymity. It should be noted that the sequence diagrams shown in FIG. 6 through FIG. 9 illustrate a series of call processing sequences.

In step S101, the user apparatus 1 accepts a power supply operation of a user and transitions to a start-up state. It is omitted in the figures but, in the start-up state, the user apparatus 1 receives LTE broadcast information available for the user apparatus 1 and selects an available network or a higher use priority network set in the UICC. After selecting the network, the user apparatus 1 sets a radio channel between the user apparatus 1 and the eNB 2. In the case where the setting the radio channel has failed, the user apparatus 1 may perform the same operation by selecting another network, or may transition to a “Limited Service State”.

It should be noted that it is omitted in the figures but it is possible for the eNB 2 to set information indicating “whether an IMS emergency call is supported” in the broadcast information, and transmit the broadcast information to the user apparatus 1. It should be noted that it is specified in the 3GPP standards that it is possible for the user apparatus 1 to make an emergency call in the “Limited Service State” only in the case where the information indicating “an emergency call is supported” has been reported to the user apparatus 1 by using the broadcast information.

In step S102, in the case where an UICC is inserted in the user apparatus 1, E-UTRAN Initial Attach procedures are performed between the user apparatus 1 and each apparatus of the EPC, and the user apparatus 1 transitions to a state in which the user apparatus is attached to the EPC (a connected state). It should be noted that the processing steps of step S102 are not performed in the case where an UICC is not inserted in the user apparatus 1.

Here, it is specified in the LTE standards that, in the case where a UICC is not inserted in the user apparatus 1, where a UICC is inserted in the user apparatus 1 but the user apparatus 1 has failed in attachment, or where the user apparatus 1 cannot receive communication services due to some reason including a reason that the user apparatus 1 is in a specific area in which the communication services cannot be received, the user apparatus 1 is supposed to transition to a state called “Limited Service State”. It should be noted that a user apparatus 1 in the “Limited Service State” can receive broadcast information of a serving cell.

In step S103, the user apparatus 1 transmits an emergency report according to an instruction from the user. Here, the subsequent processing steps differ according to whether the user apparatus 1 is in a normal state (in a state where an UICC is inserted and the attachment has been completed), or in a limited service state. In the case where the user apparatus 1 is in a normal state, the process moves to processing steps of step S104. In the case where the user apparatus 1 is in a limited service state and where an UICC is not inserted and the attachment cannot be performed, the process moves to processing steps of step S105. In the case where the user apparatus 1 is in a limited service state and where an UICC is inserted in the user apparatus 1 but the attachment cannot be performed for some reason, the process moves to processing steps of step S106.

In step S104, the user apparatus 1 transmits a “PDN Connectivity Request (Type: Emergency)” signal to the MME 3. After processing steps of step S104 are completed, the process moves to processing steps of steps S107 through S112.

In step S105, the user apparatus 1 transmits an “Attach Request (Type: Emergency, IMEI)” signal to the MME 3. After processing steps of step S105 are completed, the process moves to processing steps of steps S119 through S124.

It should be noted that, as described above, it is possible for the user apparatus 1 in a “Limited Service State” to make an emergency call only in the case where the information indicating “an emergency call is supported” has been included in the received broadcast information.

In step S106, the user apparatus 1 transmits an “Attach Request (Type: Emergency, IMSI or TMSI)” signal to the MME 3. It should be noted that, in the case where the user apparatus 1 has succeeded in location registration before transitioning to the Limited Service State, the user apparatus 1 includes in the Attach Request signal a Temporary Mobile Subscriber Identity (TMSI) instead of an IMSI, and transmits the Attach Request signal to the MME 3. In the case where the user apparatus 1 has not succeeded in location registration even once, the user apparatus 1 includes an IMSI in the Attach Request signal, and transmits the Attach Request signal to the MME 3. After processing steps of step S106 are completed, the process moves to processing steps of steps S113 through S118.

It should be noted that, as described above, it is possible for the user apparatus 1 in the “Limited Service State” to make an emergency call only in the case where the information indicating “an emergency call is supported” has been included in the received broadcast information.

In step S107, the MME 3 generates a GTP Create Session Request signal which includes an MSISDN, an IMSI, and location information (e.g., cell ID) of the user apparatus 1 obtained in the attach procedures performed in step S102.

In step S108 and step S109, the MME 3 transmits the GTP Create Session Request signal generated in step S107 to the PGW 5 via the SGW 4. It should be noted that the GTP Create Session Request signal is used for emergency call bearer setting.

In step S110, the PGW 5 allocates to the user apparatus 1 a transmission source IP address (hereinafter, referred to as “terminal IP address”) used by the user apparatus 1 for communicating with the P-CSCF 7.

In step S111, the PGW 5 transmits a PCRF setting signal to the PCRF 5. In the PCRF setting signal, an IMSI, an MSISDN, location information, and a terminal IP address of the user apparatus 1 are included.

In step S112, the communication unit 11 of the PCRF 6 stores as the terminal information in the storage unit 12 the IMSI, the MSISDN, the location information, and the terminal IP address of the user apparatus 1 included in the PCRF setting signal received from the PGW 5.

In step S113, the MME 3 generates the GTP Create Session Request signal which includes the IMSI of the user apparatus 1, the location information of the user apparatus 1 (e.g., a cell ID, a Tracking Area (TA), a Routing Area (RA), a Location Area (LA), a Geolocation Identifier, a Service Area, or location information mapping to the cell ID, etc., defined by an operator) included in the Attach Request signal received in step S106. It should be noted that, in the case where an IMEI is received in step S106, the MME 3 retrieves an IMSI from the received IMEI, and generates the GTP Create Session Request signal.

In step S114 and step S115, the MME 3 transmits the GTP Create Session Request signal generated in step S113 to the PGW 5 via the SGW 4. It should be noted that the GTP Create Session Request signal is used for emergency call bearer setting.

In step S116, the PGW 5 allocates to the user apparatus 1 a terminal IP address used by the user apparatus 1 for communicating with the P-CSCF 7.

In step S117, the PGW 5 transmits a PCRF setting signal to the PCRF 5. In the PCRF setting signal, an IMSI, location information, and the terminal IP address of the user apparatus 1 are included.

In step S118, the communication unit 11 of the PCRF 6 stores as the terminal information in the storage unit 12 the IMSI, the location information, and the terminal IP address of the user apparatus 1 included in the PCRF setting signal received from the PGW 5.

In step S119, the MME 3 generates a GTP Create Session Request signal which includes the IMEI and the location information (e.g., cell ID) of the user apparatus 1 included in the Attach Request signal received in step S105.

In step S120 and step S121, the MME 3 transmits the GTP Create Session Request signal generated in step S119 to the PGW 5 via the SGW 4. It should be noted that the GTP Create Session Request signal is used for emergency call bearer setting.

In step S122, the PGW 5 allocates to the user apparatus 1 a terminal IP address used by the user apparatus 1 for communicating with the P-CSCF 7.

In step S123, the PGW 5 transmits a PCRF setting signal to the PCRF 5. In the PCRF setting signal, the IMEI, the location information, and the terminal IP address of the user apparatus 1 are included.

In step S124, the communication unit 11 of the PCRF 6 stores as the terminal information in the storage unit 12 the IMEI, the location information, and the terminal IP address of the user apparatus 1 included in the PCRF setting signal received from the PGW 5.

In step S125, the user apparatus 1 performs EPC bearer setting steps for an emergency call with apparatuses belonging to the EPC. It should be noted that in the setting steps, an IP address of the P-CSCF 7 is reported from the POW 5 to the user apparatus 1. Though not specifically illustrated in the figure, information related to emergency call policy of a network, including availability of making an emergency call, availability of making an anonymous call according to the UICC existence, necessity of a callback from a Public Safety Answering Point (PSAP) 9 according to a telephone number report, etc., may be transmitted from the PGW 5 to the user apparatus 1 at the same time as the IP address of the P-CSCF 7 is transmitted.

The processing steps of step S125 are completed by transmitting an Attach Accept signal from the MME 3 to the user apparatus 1. Though not specifically illustrated in the figure, information related to emergency call policy of a network, including availability of making an emergency call, availability of making an anonymous call according to the UICC existence, necessity of a callback from a Public Safety Answering Point (PSAP) 9 according to a telephone number report, etc., included in the Attach Accept signal may be transmitted from the PGW 5 to the user apparatus 1.

Here, depending on whether a UICC is inserted in the user apparatus 1, the subsequent processing steps vary. In the case where the UICC is inserted in the user apparatus 1, the process moves to processing steps of step S126. In the case where the UICC is not inserted in the user apparatus 1, the process moves to processing steps of step S128.

In step S126, the user apparatus 1 performs IMS Emergency Registration steps with the P-CSCF 7. In the case where the IMS Emergency Registration steps are completed normally, the process moves to processing steps of step S127. In the case where the IMS Emergency Registration steps are not completed normally for some reason, the process moves to processing steps of step S128.

In step S127, the user apparatus 1 transmits a SIP INVITE signal to the P-CSCF 7. In the SIP INVITE signal, an IMSI, an MSISDN, an IMEI, and a terminal IP address of the user apparatus 1 are included. After processing steps of step S127 are completed, the process moves to processing steps of step S129.

In step S128, the SIP INVITE signal is transmitted to the P-CSCF 7. The SIP INVITE signal includes an identifier indicating that the signal is an anonymous outgoing call (for example, a character string including “Anonymous” is set as a value indicating a caller), the IMEI and the terminal IP address of the user apparatus 1.

After processing steps of step S128 are completed, the process moves to processing steps of step S129. It should be noted that, in the case where a UICC is not inserted in the user apparatus 1, or, in the case where a UICC is inserted in the user apparatus 1 but the IMS Emergency Registration steps have failed for some reason, the user apparatus 1 makes an anonymous emergency call (transmits a SIP INVITE signal in which “Anonymous” is set).

The user apparatus 1 may determine whether the IMS Emergency Registration steps and the transmission of the SIP INVITE should be performed based on the information related to emergency call policy of a network (availability of making an emergency call, availability of making an anonymous call according to the UICC existence, necessity of a callback from a Public Safety Answering Point (PSAP) 9 according to a telephone number report, etc.,) and the information indicating “whether the IMS emergency call is supported” reported by the broadcast information. Further, based on the above information, the user apparatus 1 may determine, for example, whether an anonymous emergency call should be made when the IMS Emergency Registration steps have failed, whether the processing steps should be based on step S127 or step S128 in the case of transmitting the SIP INVITE signal, and which information should be set in the SIP INVITE signal.

In step S129, the anonymity determination unit 22 of the P-CSCF 7 determines whether “Anonymous” is set in the SIP INVITE signal received from the user apparatus 1. In the case where “Anonymous” is set, the anonymity determination unit 22 determines that the received SIP INVITE signal is an anonymous emergency call. In the case where “Anonymous” is not set, the anonymity determination unit 22 determines that the received SIP INVITE signal is a normal emergency call. Here, in the case where it is determined that the signal is an anonymous emergency call, the process moves to processing steps of step S130, and, in the case where it is determined that the signal is a normal emergency call, the process moves to processing steps of step S133. It should be noted that, even in the case where it is determined that the signal is a normal emergency call, the terminal information obtaining unit 23 of the P-CSCF 7 may obtain location information of the user apparatus 1 from the PCRF 6 according to processing steps similar to step S130 and step S131.

In step S130, the terminal information obtaining unit 23 of the P-CSCF 7 transmits an information obtaining request to the PCRF 6. The information obtaining request includes the IMEI and/or the terminal IP address received from the user apparatus 1 in the processing steps of step S128.

In step S131, the terminal information transmission unit 13 of the PCRF 6 searches the terminal information by using as a key the IMEI or the terminal IP address included in the information obtaining request received in the processing steps of step S130. In the case where the IMSI, the MSISDN, and the location information of the user apparatus 1 are included in the terminal information (that is, in the case where the processing steps of step S118 have been performed), the terminal information transmission unit 13 of the PCRF 6 transmits an information obtaining response including the IMSI, the MSISDN, and the location information of the user apparatus 1 to the P-CSCF 7. In the case where only the location information of the user apparatus 1 is included in the terminal information (that is, in the case where the processing steps of step S124 have been performed), the terminal information transmission unit 13 of the PCRF 6 transmits an information obtaining response including the location information of the user apparatus 1 to the P-CSCF 7.

In step S132, the call continuity determination unit 24 of the P-CSCF 7 determines whether the call processing of the emergency call should be continued. In the case where the IMSI is included in the information obtaining response received in step S132, the call continuity determination unit 24 determines to continue the call processing, and moves to processing steps of step S133. In the case where the IMSI is not included in the information obtaining response received in step S132 and it is indicated in the permission information that the connection of an emergency call from the user apparatus 1 in which a UICC is not inserted should be allowed, the call continuity determination unit 24 determines to continue the call processing and moves to processing steps of step S133. In the case where the IMSI is not included in the information obtaining response received in step S132 and it is indicated in the permission information that the connection of an emergency call from the user apparatus 1 in which a UICC is not inserted should not be allowed, the call continuity determination unit 24 determines to reject the call processing and moves to processing steps of step S136.

In step S133, the communication unit 21 of the P-CSCF 7 transmits a SIP INVITE signal to the E-CSCF 8. It should be noted that, in the case where the IMSI, the MSISDN, and the location information of the user apparatus 1 are received in processing steps of step S131, the communication unit 21 transmits a SIP INVITE signal including the IMSI, the MSISDN, and the location information of the user apparatus 1 to the E-CSCF 8. In the case where only the location information of the user apparatus 1 is received in processing steps of step S131, the communication unit 21 transmits a SIP INVITE signal including the location information of the user apparatus 1 to the E-CSCF 8.

In step S134, the PSAP selection unit 33 of the E-CSCF 8 searches the PSAP information by using as a key the location information of the user apparatus 1 received in step S133, and selects a Public Safety Answering Point (PSAP) 9 of a location appropriate for the transfer destination of the emergency call.

In step S135, the PSAP communication unit 34 of the E-CSCF 8 transmits a SIP INVITE signal to the Public Safety Answering Point (PSAP) 9. It should be noted that, in the case where the IMSI, the MSISDN, and the location information of the user apparatus 1 are received in processing steps of step S133, the PSAP communication unit 34 transmits a SIP INVITE signal including the IMSI, the MSISDN, and the location information of the user apparatus 1 to the Public Safety Answering Point (PSAP) 9. In the case where only the location information of the user apparatus 1 is received in processing steps of step S133, the communication unit 34 transmits a SIP INVITE signal including only the location information of the user apparatus 1 to the Public Safety Answering Point (PSAP) 9. It should be noted that, after processing steps of step S135 are completed, a U-plane signal will be transmitted and received between the user apparatus 1 and the Public Safety Answering Point (PSAP) 9. In other words, it is possible for the user apparatus 1 to actually communicate with the Public Safety Answering Point (PSAP) 9.

In step S136, the call continuity determination unit 24 of the P-CSCF 7 transmits a SIP signal including a response code indicating connection rejection to the user apparatus 1. As a response code indicating connection rejection, for example, 380 or 403 may be used. Further, as another response code, for example, 4xx, 5xx, 6xx, etc., may be used based on the operator policy.

<Effect>

As described above, in a mobile communication system according to an embodiment, in the case where an anonymous emergency call is made by the user apparatus 1, the P-CSCF 7, which has received the emergency call, queries the PCRF 6 about whether an IMSI of the user apparatus 1 is stored and determines whether a UICC is inserted in the user apparatus 1 which has made the anonymous emergency call.

With the above arrangement, it is possible for the mobile communication system according to an embodiment to, in the case where an emergency call is made by the user apparatus 1 in which a UICC is not inserted, determine whether the connection to an emergency agency should be actually allowed based on the laws in each country.

Further, in a mobile communication system according to an embodiment, in the case where the connection of the anonymous emergency call of the user apparatus 1 is allowed, location information of the user apparatus 1 is reported to the E-CSCF 8 and the Public Safety Answering Point (PSAP) 9.

With the above arrangement, it is possible for the mobile communication system according to an embodiment to, in the case where an anonymous emergency call is made, obtain location information of the user apparatus 1 and transfer the emergency call to a Public Safety Answering Point (PSAP) 9 of an appropriate location. Further, with the above arrangement, even in the case where an emergency call is made with anonymity, it is possible for the Public Safety Answering Point (PSAP) 9 to obtain location information of the user apparatus 1.

Further, in a mobile communication system according to an embodiment, in the case where an anonymous emergency call is made by the user apparatus 1 and where it is determined that a UICC is inserted in the user apparatus 1, the MSISDN of the user apparatus 1 obtained from the PCRF 6 is reported to the Public Safety Answering Point (PSAP) 9.

With the above arrangement, it is possible for the mobile communication system according to an embodiment to, in the case where the emergency call connected between the user apparatus 1 and the Public Safety Answering Point (PSAP) 9 is disconnected for some reason, provide a callback (a returning call) from the Public Safety Answering Point (PSAP) 9.

<Summary>

As described above, a SIP control apparatus is provided. The SIP control apparatus is connected to a management apparatus controlling call processing rules in an IP packet network, and controls an emergency call made by a user apparatus. The SIP control apparatus includes an obtaining unit configured to, in the case where an emergency call connection request received from the user apparatus is anonymous, obtain an international mobile subscriber identifier, IMSI, of the user apparatus from the management apparatus; and a selection unit configured to, in the case where the obtaining unit succeeds in obtaining the IMSI of the user apparatus from the management apparatus, select to continue processing the emergency call connection request, and, in the case where the obtaining unit fails to obtain the IMSI of the user apparatus from the management apparatus, select whether to continue or to reject processing the emergency call connection request.

Further, the SIP control apparatus may include a transmission unit configured to, in the case where the selection unit selects to continue processing the emergency call connection request from the user apparatus, transmit an emergency call connection request signal to an emergency call session control apparatus.

Further, the obtaining unit further obtains location information of the user apparatus from the management apparatus, and, in the case where the selection unit selects to continue processing the emergency call connection request from the user apparatus, the transmission unit may transmit the emergency call connection request signal which includes the location information of the user apparatus.

Further, the obtaining unit further obtains a telephone number of the user apparatus from the management apparatus, and, in the case where the obtaining unit succeeds in further obtaining the telephone number of the user apparatus and where the selection unit selects to continue processing the emergency call connection request from the user apparatus, the transmission unit may transmit the emergency call connection request signal which includes the telephone number of the user apparatus.

Further, in the case where the selection unit selects to reject processing the emergency call connection request from the user apparatus, the transmission unit may transmit a SIP signal including a response code indicating connection rejection to the user apparatus.

Further, the SIP control apparatus may be a P-CSCF used in an IMS.

Further, according to an embodiment, a mobile communication system is provided. The mobile communication system includes a management apparatus for controlling call processing rules in an IP packet network, a SIP control apparatus for controlling an emergency call made by a user apparatus, and an emergency call session control apparatus connected to a plurality of public safety answering points, PSAPs, for accepting an emergency call. The management apparatus includes a storage unit configured to obtain and store an international mobile subscriber identifier, IMSI, from the user apparatus, and a first transmission unit configured to transmit the IMSI of the user apparatus in the case where the IMSI of the user apparatus is stored in the storage unit. The SIP control apparatus includes an obtaining unit configured to, in the case where an emergency call connection request received from the user apparatus is anonymous, obtain an international mobile subscriber identifier, IMSI, of the user apparatus from the management apparatus; and a first selection unit configured to, in the case where the obtaining unit succeeds in obtaining the IMSI of the user apparatus from the management apparatus, select to continue processing the emergency call connection request, and, in the case where the obtaining unit fails to obtain the IMSI of the user apparatus from the management apparatus, select whether to continue or to reject processing the emergency call connection request; and a second transmission unit configured to transmit an emergency call connection request signal to the emergency call session control apparatus in the case where the selection unit selects to continue processing the emergency call connection request from the user apparatus. The emergency call session control apparatus includes a second selection unit configured to, in the case where the emergency call connection request signal is received, select any one of the PSAPs to which the emergency call connection request signal is to be transmitted.

Further, according to an embodiment, an emergency call control method performed by a mobile communication system is provided. The mobile communication system includes a management apparatus for controlling call processing rules in an IP packet network, a SIP control apparatus for controlling an emergency call made by a user apparatus, and an emergency call session control apparatus connected to a plurality of Public Safety Answering Points, PSAPs, for accepting an emergency call. The emergency call control method includes a step of obtaining, by the management apparatus, an international mobile subscriber identifier, IMSI, from the user apparatus, and storing the IMSI in a storage unit; a step of obtaining, by the SIP control apparatus, the IMSI of the user apparatus from the management apparatus in the case where an emergency call connection request received from the user apparatus is anonymous; a step of selecting, by the SIP control apparatus, to continue processing the emergency call connection request in the case where the IMSI of the user apparatus is obtained from the management apparatus, and, selecting whether to continue or to reject processing the emergency call connection request in the case where the IMSI of the user apparatus is not obtained from the management apparatus; a step of transmitting, by the SIP control apparatus, an emergency call connection request signal to the emergency call session control apparatus in the case where the selection unit selects to continue processing the emergency call connection request from the user apparatus; and a step of selecting, by the emergency call session control apparatus, any one of the PSAPs to which an emergency call connection request signal is to be transmitted in the case where the emergency call connection request signal is received.

Further, the “unit” included in each of the above apparatuses may be substituted for by “means”, “circuit”, “device”, etc.

### Supplementary Description of Embodiment

As described above, embodiments have been described. The disclosed invention is not limited to these embodiments, and a person skilled in the art would understand various variations, modifications, replacements, or the like. Specific examples of numerical values have been used for encouraging understanding of the present invention. These numeric values are merely examples and, unless otherwise noted, any appropriate values may be used. In the above description, partitioning of items is not essential to the present invention. Matters described in more than two items may be combined if necessary. Matters described in one item may be applied to matters described in another item (as long as they do not conflict). In a functional configuration diagram, boundaries of functional units or processing units do not necessarily correspond to physical boundaries of parts. Operations of multiple functional units may be physically performed in a single part, or operations of a single functional unit may be physically performed by multiple parts. The order of steps in the above described sequences and flowcharts according to an embodiment may be changed as long as there is no contradiction. For the sake of description convenience, the PCRF 6, the P-CSCF 7, and the E-CSCF 8 have been described using functional block diagrams. These apparatuses may be implemented by hardware, by software, or by combination of both. The software which is executed by a processor (CPU) included in the PCRF 6 according to an embodiment, the software which is executed by a processor (CPU) included in the P-CSCF 7 according to an embodiment, and the software which is executed by a processor included in the E-CSCF 8 according to an embodiment may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium.

The present invention is not limited to the above embodiments, and various variations, modifications, alternatives, replacements, etc., may be included in the present invention without departing from the spirit of the invention.

It should be noted that the RCRF 6 is an example of a management apparatus in an embodiment. The P-CSCF 7 is an example of a SIP control apparatus. The E-CSCF 8 is an example of an emergency call session control apparatus. The terminal information obtaining unit 23 is an example of an obtaining unit. The call continuity determination unit 24 is an example of a selection unit or a first selection unit. The communication unit 21 is an example of a transmission unit or a second transmission unit. The storage unit 12 is an example of a storage unit. The communication unit 11 is an example of a first transmission unit. The PSAP selection unit 33 is an example of a second selection unit.

The present application is based on and claims the benefit of priority of Japanese Priority Application No. 2015-082006 filed on Apr. 13, 2015, the entire contents of which are hereby incorporated by reference.

### DESCRIPTION OF THE REFERENCE NUMERALS

1 User apparatus
2 eNB
3 MME
4 SGW
5 PGW
6 PCRF
7 P-CSCF
8 E-CSCF
9 Public safety answering point (PSAP)
11 Communication unit
12 Storage unit
13 Terminal information transmission unit
21 Communication unit
22 Anonymity determination unit
23 Terminal information obtaining unit
24 Call continuity determination unit
31 Communication unit
32 Storage unit
33 PSAP selection unit
34 PSAP communication unit
101 CPU
102 ROM
103 RAM
104 HDD
105 Operation unit
106 Display unit
107 Drive apparatus
108 NIC

1. A SIP control apparatus which is connected to a management apparatus controlling call processing rules in an IP packet network, and controls an emergency call made by a user apparatus, the SIP control apparatus comprising:
an obtaining unit configured to, in the case where an emergency call connection request received from the user apparatus is anonymous, obtain an international mobile subscriber identifier, IMSI, of the user apparatus from the management apparatus; and
a selection unit configured to, in the case where the obtaining unit succeeds in obtaining the IMSI of the user apparatus from the management apparatus, select to continue processing the emergency call connection request, and, in the case where the obtaining unit fails to obtain the IMSI of the user apparatus from the management apparatus, select whether to continue or reject processing the emergency call connection request.

2. The SIP control apparatus according to claim 1, further comprising:
a transmission unit configured to transmit an emergency call connection request signal to an emergency call session control apparatus in the case where the selection unit selects to continue processing the emergency call connection request from the user apparatus.

3. The SIP control apparatus according to claim 2, wherein the obtaining unit further obtains location information of the user apparatus from the management apparatus, and
the transmission unit transmits the emergency call connection request signal including the location information of the user apparatus in the case where the selection unit selects to continue processing the emergency call connection request from the user apparatus.

4. The SIP control apparatus according to claim 2, wherein the obtaining unit further obtains a telephone number of the user apparatus from the management apparatus, and
the transmission unit transmits the emergency call connection request signal including the telephone number of the user apparatus in the case where the telephone number of the user apparatus is further obtained by the obtaining unit from the management apparatus and where the selection unit selects to continue processing the emergency call connection request from the user apparatus.

5. The SIP control apparatus according to claim 2, wherein the transmission unit transmits a SIP signal including a response code indicating connection rejection to the user apparatus in the case where the selection unit selects to reject processing the emergency call connection request from the user apparatus.

6. The SIP control apparatus according to claim 1, wherein the SIP control apparatus is a P-CSCF used in an IMS.

7. A mobile communication system comprising:
a management apparatus for controlling call processing rules in an IP packet network,
a SIP control apparatus for controlling an emergency call made by a user apparatus, and
an emergency call session control apparatus connected to a plurality of public safety answering points, PSAPs, for accepting an emergency call, wherein
the management apparatus includes
a storage unit configured to obtain and store an international mobile subscriber identifier, IMSI, from the user apparatus, and
a first transmission unit configured to transmit the IMSI of the user apparatus in the case where the IMSI of the user apparatus is stored in the storage unit, and
the SIP control apparatus includes
an obtaining unit configured to, in the case where an emergency call connection request received from the user apparatus is anonymous, obtain an international mobile subscriber identifier, IMSI, of the user apparatus from the management apparatus; and
a first selection unit configured to, in the case where the obtaining unit succeeds in obtaining the IMSI of the user apparatus from the management apparatus, select to continue processing the emergency call connection request, and, in the case where the obtaining unit fails to obtain the IMSI of the user apparatus from the management apparatus, select whether to continue or reject processing the emergency call connection request; and
a second transmission unit configured to transmit an emergency call connection request signal to the emergency call session control apparatus in the case where the selection unit selects to continue processing the emergency call connection request from the user apparatus, and wherein
the emergency call session control apparatus includes a second selection unit configured to, in the case where the emergency call connection request signal is received, select any one of the PSAPs to which the emergency call connection request signal is to be transmitted.

8. An emergency call control method performed by a mobile communication system including a management apparatus for controlling call processing rules in an IP packet network, a SIP control apparatus for controlling an emergency call made by a user apparatus, and an emergency call session control apparatus connected to a plurality of Public Safety Answering Points, PSAPs, for accepting an emergency call, the emergency call control method comprising:
a step of obtaining, by the management apparatus, an international mobile subscriber identifier, IMSI, from the user apparatus, and storing the IMSI in a storage unit;
a step of obtaining, by the SIP control apparatus, the IMSI of the user apparatus from the management apparatus in the case where an emergency call connection request received from the user apparatus is anonymous;
a step of selecting, by the SIP control apparatus, to continue processing the emergency call connection request in the case where the IMSI of the user apparatus is obtained from the management apparatus, and, selecting whether to continue or to reject processing the emergency call connection request in the case where the IMSI of the user apparatus is not obtained from the management apparatus;
a step of transmitting, by the SIP control apparatus, an emergency call connection request signal to the emergency call session control apparatus in the case where the selection unit selects to continue processing the emergency call connection request from the user apparatus; and
a step of selecting, by the emergency call session control apparatus, any one of the PSAPs to which an emergency call connection request signal is to be transmitted in the case where the emergency call connection request signal is received.

9. The SIP control apparatus according to claim 2, wherein the SIP control apparatus is a P-CSCF used in an IMS.

10. The SIP control apparatus according to claim 3, wherein the obtaining unit further obtains a telephone number of the user apparatus from the management apparatus, and
the transmission unit transmits the emergency call connection request signal including the telephone number of the user apparatus in the case where the telephone number of the user apparatus is further obtained by the obtaining unit from the management apparatus and where the selection unit selects to continue processing the emergency call connection request from the user apparatus.

11. The SIP control apparatus according claim 3, wherein the transmission unit transmits a SIP signal including a response code indicating connection rejection to the user apparatus in the case where the selection unit selects to reject processing the emergency call connection request from the user apparatus.

12. The SIP control apparatus according to claim 3, wherein the SIP control apparatus is a P-CSCF used in an IMS.

13. The SIP control apparatus according claim 4, wherein the transmission unit transmits a SIP signal including a response code indicating connection rejection to the user apparatus in the case where the selection unit selects to reject processing the emergency call connection request from the user apparatus.

14. The SIP control apparatus according to claim 4, wherein the SIP control apparatus is a P-CSCF used in an IMS.

15. The SIP control apparatus according to claim 5, wherein the SIP control apparatus is a P-CSCF used in an IMS.
